(19) United States
(12) Patent Application Publication
(10) Pub. No.: US 2020/0007386 A1
(43) Pub. Date: Jan. 2, 2020

(54) BACKCHANNEL DEVICE COMMUNICATIONS

(71) Applicant: Hewlett Packard Enterprise Development LP, Houston, TX (US)

(72) Inventors: Ankur Kamthe, Santa Clara, CA (US); Shruthi Koundinya, Santa Clara, CA (US)

(21) Appl. No.: 16/022,982

(22) Filed: Jun. 29, 2018

(51) Int. Cl. H04L 12/24; H04W 76/18; H04W 48/08; H04W 92/20; H04W 92/12

(52) U.S. Cl. CPC H04L 41/0672; H04W 76/18; H04W 92/12; H04W 92/20; H04W 48/08

(57) ABSTRACT

An example access point may include a backchannel device, a processing resource and a non-transitory memory resource including instructions executable by the processing resource to transmit an error message to the backchannel device indicating an error has occurred on the access point; transmit, via the backchannel device, the error message to a different backchannel device included on a different access point to alert the different access point of the error. The access point may receive, via the backchannel device, a corrective update including corrective information from the different access point; and execute corrective information included in the corrective update received by the backchannel device, wherein executing corrective information corrects the error.

### BACKGROUND

Networking devices may send and/or receive data within a computing network. Loss in connectivity of the networking device to management entities can interrupt network performance.

### BRIEF DESCRIPTION OF THE DRAWINGS

FIG. 1 illustrates an example of an access points including backchannel devices for backchannel device communications consistent with the disclosure.

FIG. 2 illustrates an example access point including a processing resource and a non-transitory machine-readable memory resource for backchannel device communications consistent with the disclosure.

FIG. 3 illustrates another example access point including a processing resource and a non-transitory machine-readable memory resource for backchannel device communications consistent with the disclosure.

FIG. 4 illustrates a system for backchannel device communication and message flow consistent with the disclosure.

FIG. 5 illustrates an example management entity including a processing resource and a non-transitory machine-readable memory resource for backchannel device communications consistent with the disclosure.

### DETAILED DESCRIPTION

Network devices may include computing devices that are adapted to transmit and/or receive signaling, and to process information within such signaling across a network. For example, a network device may include a client device, an access point, a controller, a management entity, and/or a data transfer device.

Network devices (e.g., access points) may communicate with management entity that may monitor network traffic and/or provide instructions to other access points. Sometimes, a network device may lose a network connection and/or is otherwise unable to communicate with the management entity. As used herein, the term “management entity” refers to a network device that may process information and execute instructions that affect the operation of other network devices. For example, an access point that has experienced an error, and has lost connectivity with the network, may be reset by the management entity included in the network. In this example, the access point that has lost connection may be unable to communicate the error to receive corrective action from the management entity. In this instance, the access point may be left to reboot (e.g., reset) repeatably. Said differently, absent a mechanism for the access point to communicate the error state to a management entity, the access point may be left to repeatably reboot until the error is realized by a network administrator.

Some approaches may exchange such error communications between access points and/or management entities via data logs that may be exported out of the access point via a syslog server. However, absent a connection to a management entity (e.g., a server and/or a controller), the access point may remain in a state of error. In this instance, correcting the error may be cumbersome and time consuming as the access point may remain in the error state until the error is realized by a network administrator. Further, this may prevent the discovery of the root cause of the error condition, thus preventing a correction that may avoid such errors in the future.

In contrast, examples of the present disclosure describe an access point including a backchannel device to communicate an error message when the access point has lost connectivity to a controller and/or a network. As used herein, the term “backchannel device” may be a radio transceiver that may be utilized in backchannel device communication to transmit and/or receive a radio signals from various other radio transceiver technologies. For example, a backchannel device may operate to transmit and receive radio signal from various IEEE 802.15 technologies such as, Bluetooth, Bluetooth Low Energy (BLE), ZigBee, Thread, 6LoWPAN, WirelessHART, ISA100.11a, Coexistence, High Rate WPAN, Low Rate WPAN, mesh Networking, Body area Networks, Visible Light Communication, Low Power Wide Area Network (LP-WAN), etc. As used herein, the term “backchannel communication” refers to communication between two backchannel devices. In some examples, the backchannel device communications may be utilized by access points that have lost their ability to communicate otherwise.

For example, when the access point experiences an error, it may transmit an error message to a backchannel device included on the access point. In some examples, the backchannel device may transmit the error message to a different backchannel device included on a different access point that may be connected to a management entity. In this way, the access point may use backchannel device communications to communicate an error state to a management entity utilizing its backchannel device and the backchannel devices included on neighboring access points. In this way, the root cause of the error may be communicated to a network administrator via the management entity. The management entity may process the error message and transmit corrective information using backchannel device communication to the access point that is experiencing the error via the backchannel devices of the respective access points. As used herein, the term “root cause” refers to an explanation to why/how an error may be perpetually occurring, such that correcting the root cause, may help to prevent the same error from recurring. Furthermore, a corrective action (e.g., a corrective update) may be communicated to the access point that is experiencing the error to decrease the amount of time that the access point is experiencing persistent error thus disrupting network traffic.

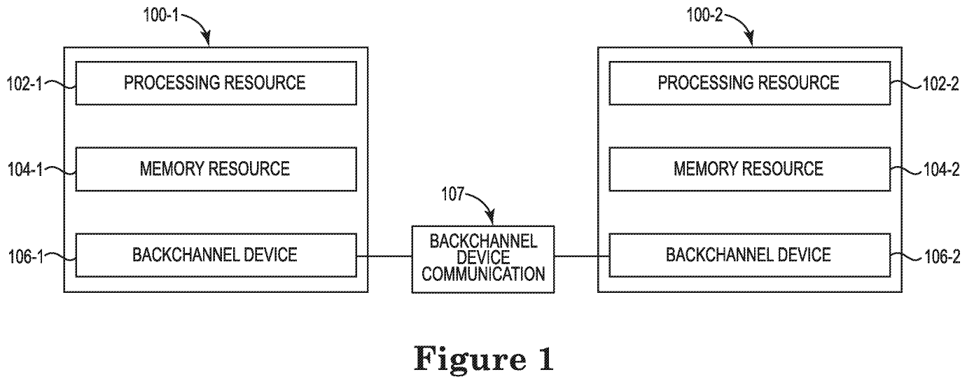

FIG. 1 illustrates an example of an access points 100-1, 100-2 including backchannel devices 106-1, 106-2 for backchannel device communications 107 consistent with the disclosure. As used herein, the term “Access Point” (AP) may include a computing device including hardware and/or a combination of hardware and instructions executable by the hardware to operate as a transmitter and/or a receiver of signals between a client device, other APs, a controller, a management entity, and/or other network devices on the network. In some examples, a first AP 100-1 and a second AP 100-2 may act as a transmitter and/or receiver of wireless radio signals for any known or convenient wireless access technology which may later become known. While the term AP may include network devices that transmit and/or receive IEEE 802.11-based Wi-Fi signals, the first AP 100-1 and the second AP 100-2 are not intended to be limited to IEEE 802.11-based APs. APs may generally function as an electronic device that is adapted to allow wireless computing devices, such as client devices, to connect to a wired network via various communications standards. While FIG. 1 illustrates two APs, the examples of the disclosure are intended to be non-limiting, and more or less than two APs are contemplated.

FIG. 1 illustrates a first AP 100-1 and second AP 100-2 which may include respective first processing resource 102-1, a second processing resource 102-2 and respective first memory resource 104-1, and second memory resource 104-2. For example, the first processing resource 102-1 and the second processing resource 102-2 may be central processing units (CPUs), semiconductor-based microprocessors, and/or other hardware devices suitable for retrieval and execution of instructions stored in a memory resource 104-1, 104-2 (e.g., in a non-transitory computer readable medium). The example first processing resource 102-1 and second processing resource 102-2 may fetch, decode, and execute instructions. As an alternative, or in addition to, retrieving and executing instructions, the example first processing resource 102-1 and second processing resource 102-2 may include an electronic circuit that may include electronic components for performing the functionality of executed instructions.

In some examples, the first processing resource 102-1 and second processing resource 102-2 may be a plurality of hardware processing units that may cause machine-readable instructions to be executed. The first processing resource 102-1 and second processing resource 102-2 may include central processing units (CPUs) among other types of processing units. The first memory resource 104-1 and the second memory resource 104-2 may be any type of volatile or non-volatile memory or storage, such as random-access memory (RAM), flash memory, storage volumes, a hard disk, or a combination thereof.

The first AP 100-1 and the second AP 100-2 may include a network device that has a wired connection to a computing network (e.g., LAN, Internet, etc.). The first AP 100-1 and the second AP 100-2 may act as a wireless connection point for client devices. As used herein, the term “client device” can, for example, refer to a device including a processing resource, memory, and input/output interfaces for wired and/or wireless communication. For example, a client device may include a laptop computer, a desktop computer, a mobile device, an Internet-of-Things device and/or other wireless devices, although examples of the disclosure are not limited to such devices. A mobile device may, for example, refer to devices that are (or may be) carried and/or worn by a user. For instance, a mobile device can be a phone (e.g., a smart phone), a tablet, a personal digital assistant (PDA), smart glasses, and/or a wrist-worn device (e.g., a smart watch), among other types of mobile devices.

As illustrated in FIG. 1, the first AP 100-1 and the second AP 100-2 may include a respective first backchannel device 106-1 and a second backchannel device 106-2 utilize backchannel device communications 107 on the network. As mentioned above, the first backchannel device 106-1 and second backchannel device 106-2 may be a radio transceiver to transmit error messages when the first AP 100-1 and/or the second AP 100-2 is in an error state. As used herein, the term “error state” refers to an instance when the first AP 100-1 and/or second AP 100-2 is not effective for its intended purpose. In some examples, the first AP 100-1 may lose connectivity with a network controller and may be in a persistent state of restarting and failing to connect to the network. In this example, because the first AP 100-1 is not communicatively connected to the network, it may not transmit an error message and/or receive corrective action from a management entity. For example, the first AP 100-1 may experience an error while operating within a network and may be unable to communicate its error state to a management entity. In this instance, communicating the error to the management entity via backchannel device communications 107 may prevent the first AP 100-1 from experiencing a persistent state of reboot (e.g., reset) and thereby disrupting network communications. When the first AP 100-1 detects an error, the first AP 100-1 may transmit an error message to the first backchannel device 106-1 such that the first backchannel device 106-1 may communicate the error message to the second backchannel device 106-2 on the second AP 100-2 which may be communicatively connected to the management entity (not expressly illustrated in FIG. 1).

As used herein, the term “error message” refers to a message that may include information relating to the error condition, the identifying characteristics of the first AP 100-1, and the network device (e.g., the network controller) to which the first AP 100-1 is attempting to connect. For example, the first AP 100-1 may generate an error message that includes identifying information about the first AP 100-1, the number of occasions the first AP 100-1 has attempted and/or failed to connect to the controller and identifying characteristics of the controller to which the first AP 100-1 has failed to connect.

In some examples, the error message generated by the first AP 100-1 may include a unique error code that indicates information related to a particular failure experienced by the first AP 100-1. For example, when the error experienced by the first AP 100-1 includes a failure of the first AP 100-1 to establish communication with a management entity, the first AP 100-1 may generate the unique error code that includes information about successive attempts to connect to the management entity and the number to successive attempts.

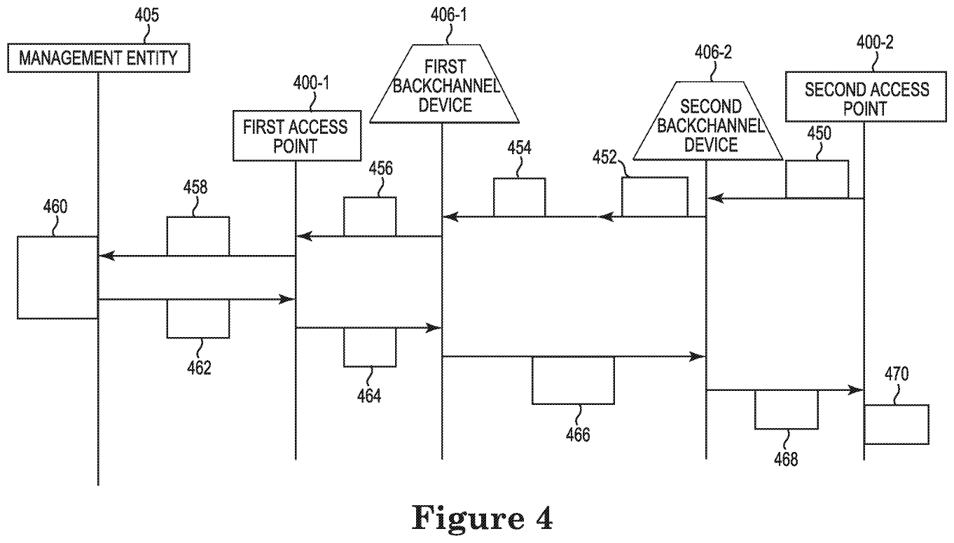

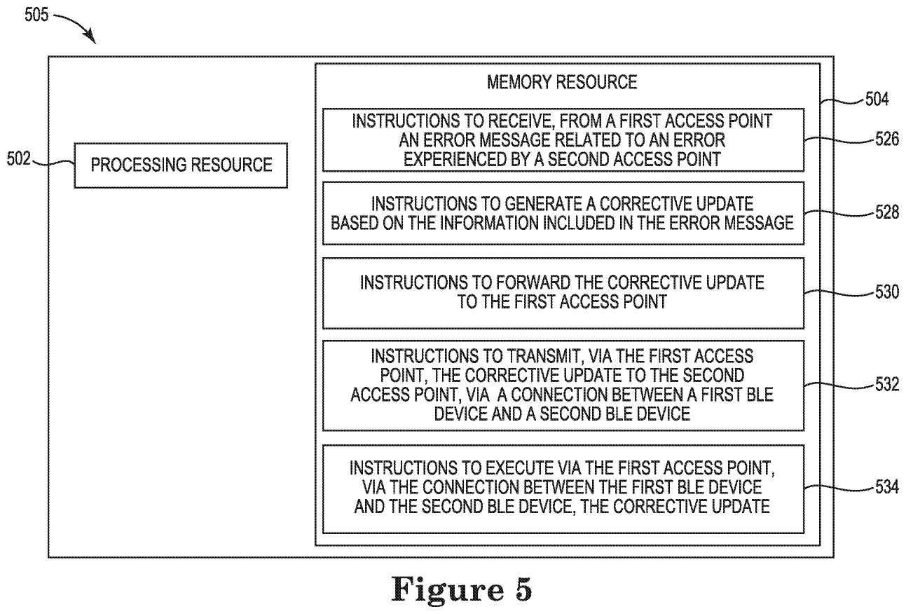

As mentioned above, the first backchannel device 106-1 may operate to communicate with the second backchannel device 106-2 that may be included on second AP 100-2 to correct the first AP 100-1 error state. For example, the first backchannel device 106-1 may transmit the error message to the second backchannel device 106-2 included on the second AP 100-2 to alert the second AP 100-2 of the error via backchannel communication. Said differently, the first backchannel device 106-1 may transmit and receive signals to/from the second backchannel device 106-2 during backchannel communications. The first backchannel device 106-1 may receive a corrective update including corrective information from a management entity via the second AP 100-2 which may include an uplink to the management entity. The direct uplink to the management entity is described in further detail herein in connection with FIGS. 4 and 5. As used herein, the term “corrective action” refers to the transmission and/or receipt of instruction that may remedy an error. As used herein, the term “corrective update” refers to a patch or instructions to provide changes to a network device that may update, fix, or otherwise improve the operation of the network device. As used herein, the term “corrective information” refers to data that is based on the information included in the error message, and in some examples, the corrective information may be in the form of bytes, and/or read/write information to be executed on a network device.

Backchannel devices according to this disclosure may provide a mechanism for a first AP 100-1 that is experiencing an error to use backchannel device communications 107 to communicate an error message to a second AP 100-2 which may have an uplink to a management entity. As used herein, the term “uplink” and/or “direct uplink” refers to a transmission path between a network device (e.g., an AP) where traffic and signal flow may traverse. In this way, a management entity may be notified that the first AP 100-1 on the network is experiencing an error, and the management entity may take action to determine the root cause of the error and provide corrective updates to the first AP 100-1 experiencing the error. The first backchannel device 106-1 according to the disclosure may participate in backchannel device communications 107 to receive the corrective update generated by the management entity from the second backchannel device 106-2 on the second AP 100-2.

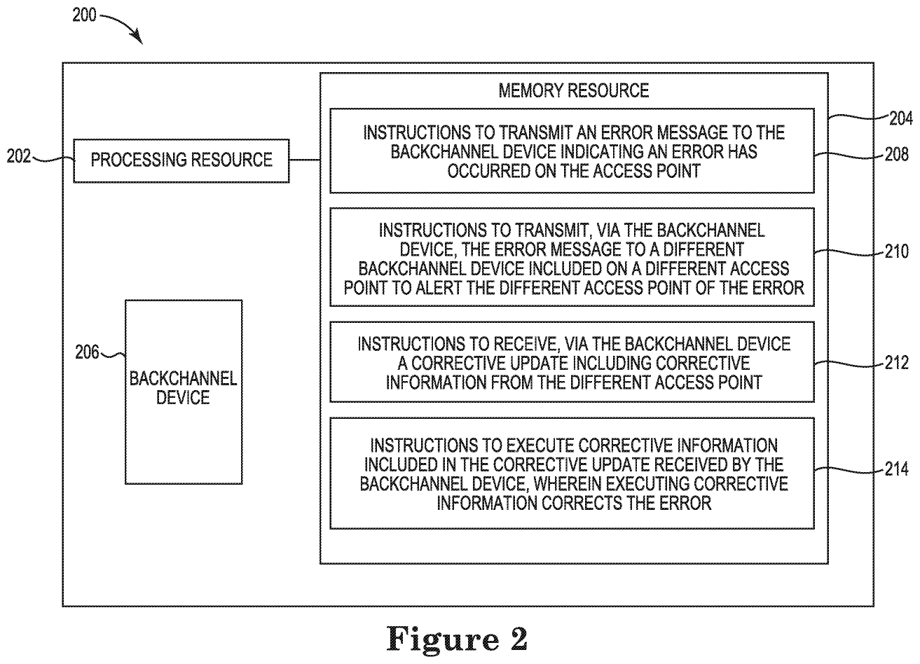

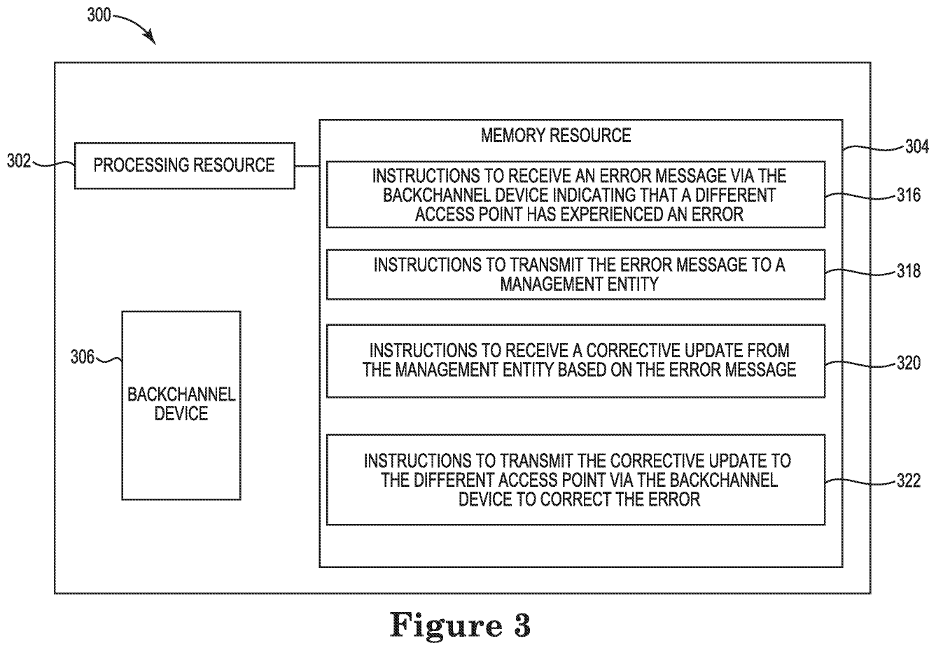

FIG. 2 illustrates an example AP 200 including a processing resource 202, a non-transitory machine-readable memory resource 204 for backchannel device communications consistent with the disclosure. The AP 200 illustrated in FIG. 2 may be analogous to the first AP 100-1 and the second AP 100-2 illustrated in FIG. 1 and include a backchannel device 206 that is analogous to the first backchannel device 106-1 and the second backchannel device 106-2 illustrated in FIG. 1. A memory resource, such as the non-transitory memory resource 204, may be used to store instructions (e.g., 208, 210, 212, and 214) executed by the processing resource 202 to perform the operations as described herein. The operations are not limited to a particular example described herein and may include additional operations such as those described with regard to the first AP 100-1 and the second AP 100-2 described in FIG. 1, the AP 300 described in FIG. 3, the system 401 in FIG. 4, and the management entity 505 illustrated in FIG. 5.

A processing resource 202 may execute the instructions stored on the non-transitory memory resource 204. The non-transitory memory resource 204 may be any type of volatile or non-volatile memory or storage, such as random-access memory (RAM), flash memory, read-only memory (ROM), storage volumes, a hard disk, or a combination thereof.

The non-transitory memory resource 204 may store instructions 208 executable by the processing resource 202 to transmit an error message to the backchannel device 206 indicating an error has occurred on the AP 200. For example, an error message may be generated by the AP 200 and transmitted by the backchannel device 206 in response to the AP 200 having experienced a failure to connect to a network controller, and the AP 200 may be repeatedly restarting in an attempt to establish the connection to the network controller. In some examples, the error message may be a special packet that includes a unique error code, an identification of the AP 200, and an identification of a management device (e.g., the controller), where the AP has failed to establish a connection with the controller. As used herein, the term “special packet” refers to a network packet that includes imbedded information for a specific purpose. For example, a special packet may be imbedded with the error message including error information such as a unique error code corresponding to the error; an identification value corresponding to the AP 200; and/or an identification of a controller, where the AP has failed to establish a connection with the controller.

The non-transitory memory resource 204 may store instructions 210 executable by the processing resource 202 to transmit, via the backchannel device 206, the error message to a different backchannel device included on a different AP (e.g., the second AP 100-2) to alert the different AP of the error experienced by the AP 200. For example, the different AP may include a different backchannel device that may transmit and/or receive communication from the backchannel device 206, thus the different AP may participate in backchannel device communication (e.g., the backchannel device communications 107 of FIG. 1) with the backchannel device 206. The different AP may be directly and/or communicatively connected to a management entity and may forward the error message from the AP 200 to the management entity. Said differently, the different AP may include an uplink to the management entity. The management entity may process the error message and transmit a corrective update back to the AP 200 via the different AP and the respective backchannel devices. In this way, using the backchannel device 206, the AP 200 may receive corrective action to relieve its error state while being disconnected from the network. In some examples, the AP 200 may alert the different AP of the error by transmitting a regular network packet via the backchannel device 206. As used herein, the term “regular network packet” refers to a network packet that may be transmitted to a different AP to indicate that the AP 200 is experiencing an error. In response to the different AP receiving the regular network packet, the different AP may request error information and/or an error message from the AP 200.

For example, the AP 200 may utilize backchannel device communications to transmit via the backchannel device 206 a regular network packet to the different AP via the backchannel device 206. In response to receiving the regular network packet, the different AP may transmit a request for information about the error experienced by the AP 200. The AP 200 may receive, via the backchannel device 206, the request for information about the error experienced by the AP 200 from the different AP in response to the different AP having received the regular network packet. In this example, the different AP may send a request for information including: a unique error code corresponding to the error; an identification value corresponding to the AP; and/or an identification of a management device, wherein the AP has failed to establish a connection with the management device. In this way, the different AP may acquire the information about the error experienced by the AP 200 such that it may forward the information to the management entity and acquire corrective action which may be transmitted back to the AP 200 via the respective backchannel devices.

The non-transitory memory resource 204 may store instructions 212 executable by the processing resource 202 to receive, via the backchannel device 206, a corrective update including corrective information from the different AP. In this example, the corrective update may be obtained by the different AP from the management entity to which the different AP is directly and/or communicatively coupled. The different AP may transmit the corrective update to the different backchannel device, such that the different backchannel device may communicate with the backchannel device 106. In this way, because the backchannel devices that reside on the respective APs are able to communicate using backchannel communication, the AP 200 may receive the corrective update to alleviate the error causing the AP 200 to be disconnected from the network.

The non-transitory memory resource 204 may store instructions 214 executable by the processing resource 202 to execute the corrective information included in the corrective update received by the backchannel device 206, where executing corrective information corrects the error experienced by the AP 200. For example, the backchannel device 206 may receive the corrective update via the different backchannel device. The backchannel device 206 may have transmitted the corrective update to the AP 200 such that is may be executed to correct the error. In this way, the AP 200 may receive corrective information to fix the error, without having been connected to the network.

As described by examples in connection with FIG. 2, using backchannel device communication by backchannel devices included in respective APs to transmit status/error information about the APs to a management entity allows for corrective information to be transmitted from the same management entity to correct the error experienced by the AP 200. Further, the error message transmitted via backchannel devices to the management entity provides information about the root cause of the failure of the AP 200 because the management entity may forward that information to a network administrator, which may have otherwise been inaccessible.

FIG. 3 illustrates another example AP 300 including a processing resource 302 and a non-transitory machine-readable memory resource 304 for backchannel device communications consistent with the disclosure. The AP 300, the processing resource 302, the non-transitory memory resource 304, and the backchannel device 306 illustrated in FIG. 3 may be analogous to the elements illustrated in FIGS. 1 and 2. A memory resource, such as the non-transitory memory resource 304, may be used to store instructions (e.g., 316, 318, 320, and 322) executed by the processing resource 302 to perform the operations as described herein. The operations are not limited to a particular example described herein and may include additional operations such as those described with regard to the first AP 100-1 and the second AP 100-2 described in FIG. 1, the AP 200 described in FIG. 2, the system 401 in FIG. 4, and the management entity 505 illustrated in FIG. 5.

In some examples, the AP 300 may include a direct uplink to a management entity to transmit and receive an error message from a different AP that is not connected to the management entity. In this way, the AP 300 may forward information about the different AP within the network to the management entity such that the management entity may transmit corrective updates to the different AP experiencing an error. For example, the non-transitory memory resource 304 may store instructions 316 executable by the processing resource 302 to receive an error message via the backchannel device 306 indicating that a different AP has experienced an error. In an example, the error message may be in the form of a special packet transmitted by the different AP via the different backchannel device. In this example, the processing resource 302 may determine, based on the special packet having been received from the different AP, an error code indicating the error experienced by the different AP, the identity of the different AP, and/or a type of failure experienced by the different AP. In other examples, the different AP may transmit, via the different backchannel device, a regular network packet which may indicate that the different AP is experiencing an error.

For example, the different AP, via the different backchannel device, may transmit a regular network packet to the backchannel device 306 to indicate that the different AP is experiencing an error. In this example, the AP 300 may transmit a request packet to the backchannel device 306, and the backchannel device 306 may transmit the request packet to the different backchannel device to request the error message from the different AP. Said differently, the AP 300 may receive the error message from the backchannel device 306 in response to executing instruction for the backchannel device 306 to transmit a request packet to the different AP. In this way, the AP 300 may forward the error message to the management entity by requesting the error information from the different AP.

Regardless of whether the AP 300 requests the error message from the different AP or the error message is a special packet transmitted from the different AP, the AP 300 may forward the error message to the management entity of which it is directly and/or communicatively connected (e.g., uplinked). For example, the non-transitory memory resource 304 may store instructions 318 executable by the processing resource 302 to transmit the error message to the management entity via the direct uplink of the AP 300. In this way, the management entity may process the error message and determine if there is a corrective update that the management entity may provide to the AP 300 to transmit via the backchannel device 306 to the different AP that is experiencing the error. Further, the management entity may process the error message to determine, based on the error information within the error message, the root cause of the error. The management entity may take action to alert a network administrator of the error such that further network disruption may be avoided. The management entity may generate the corrective update for the different AP that is experiencing the error and utilize backchannel device communication (e.g., the backchannel device communication 107 of FIG. 1) to transmit the corrective update.

For example, the management entity may transmit the corrective update from to the AP 300 such that backchannel device communications may be utilized to execute the corrective update onto the different AP. For example, the non-transitory memory resource 304 may store instructions 320 executable by the processing resource 302 to receive the corrective update from the management entity based on the error message. In this way, the AP 300 may provide the corrective update to the different AP to correct the error.

For example, the backchannel device 306 and the different backchannel device may participate in backchannel device communication to transmit and receive information about the error experienced by the different AP. Further, using backchannel communication, the error may be corrected even when the different AP is disconnected from the network. Said differently, the non-transitory memory resource 304 may store instructions 322 executable by the processing resource 302 to transmit the corrective update to the different AP via the backchannel device to correct the error, where the corrective update is received by a different backchannel device that is included on the different AP. In some examples, the backchannel device communication between the backchannel device 306 and the different backchannel device may be used to correct the error utilizing a remote attestation service.

As used herein, the term “remote attestation” refers to an application included on an AP (e.g., the AP 200) that a network administrator may remotely control to execute the corrective solution onto the different AP that is experiencing an error to correct the error. For example, the memory resource 304 further include instructions executable by the processing resource 302 to execute the corrective update onto the different AP using a remote attestation service included on the different AP, where executing the corrective update corrects the error. In some examples, the backchannel device communication may permit the corrective update to be transmitted through byte characteristics to the remote attestation service included on the different AP.

As described by examples in connection with FIG. 3, backchannel device communication allows for the AP 300 to communicate with a different AP to correct an error experienced by the different AP. Because the AP 300 has a direct uplink to a management entity, the AP 300 is able to provide recovery to the different AP. Further, the error message transmitted via the backchannel devices to the management entity may provide information about the root cause of the failure of the AP 300, which may have otherwise been inaccessible.

FIG. 4 illustrates a system for backchannel device communication and message flow consistent with the disclosure. FIG. 4 illustrates a system 403 including a first AP 400-1 which includes a first backchannel device 406-1 (e.g., a first BLE device), a second AP 400-2 which includes a second backchannel device 406-2 (e.g., a second BLE device), and a management entity 405. The elements included in system 403 are analogous to the elements described in connection with FIGS. 1, 2, and 3. Although not shown in FIG. 4, as to not obscure the examples of the disclosure, the first AP 400-1 and the second AP 400-2 may both include a processing resource (e.g., processing resource 102) and a memory resource (e.g., memory resource 104). Additionally, two APs are illustrated in FIG. 4 as non-limiting examples, and it should be understood that there may be more, or less than two AP included in the system 403. In some examples, the second AP 400-2 may determine that it is experiencing an error.

For example, at box 450, the second AP 400-2 may determine a loss of connectivity with a controller when successive connection attempts to the controller have failed. In this example, the second AP 400-2 may determine that a particular number of successive connection attempts have failed. When the second AP 400-2 makes that determination, the second AP 400-2 may transmit an error message to the second backchannel device 406-2. For example, the second AP 400-2 may attempt to restart to establish connection with the controller twice, and after the two successive failures to connect with the controller, the second AP 400-2 may transmit an error message to the second backchannel device 406-2. The second backchannel device 406-2 may broadcast the error message to neighboring backchannel devices (e.g., the first backchannel device 406-1). Note that two successive restart attempts are described as a non-limiting example. It should be understood that any number of attempts are contemplated in the examples described herein.

As illustrated in FIG. 4, at block 452, the second backchannel device 406-2 may utilize multiple ways of broadcasting the error message. In one example, the second backchannel device 406-2 may transmit the error message in a special packet, where the error message includes the unique error code, the identification information of the second AP 400-2, and information related to the controller that the second AP 400-2 has failed to connect. In another example, the second backchannel device 406-2 may transmit a regular network packet, which in turn may elicit scan requests from the neighboring first AP's 400-1 first backchannel device 406-1. As described herein, the regular network packet may elicit the neighboring first AP 400-1 to request the error message from the second AP 400-2.

For example, the first backchannel device 406-1 included on the first AP 400-1 may, at block 454, scan for network packets as part of its operation. When the first AP 400-1 receives a special packet, it may extract the error message and forward as described herein. However, when the first backchannel device 406-1 receives a regular network packet from the second backchannel device 406-2, it may transmit a request for the error information. When the first backchannel device 406-1 receives the error information it may forward it to the first AP 400-1.

For example, at block 456, the first backchannel device 406-1 may forward the error information from the error message to the first AP 400-1 which may include an uplink to the management entity 405. Although not illustrated in FIG. 4, as to not obscure the examples of the disclosure, the management entity 405 may include a processing resource (e.g., the processing resource 102) and a memory resource (e.g., the memory resource 104) and an uplink to the first AP 400-1. The management entity 405 may, at box 458, receive, from the first AP 400-1, an error message related to an error experienced by the second AP 400-2, where the error message was transmitted from the second backchannel device 406-2 device included on the second AP 400-2 and received by the first backchannel device 406-1 on the first AP 400-1. The processing resource included in the management entity 405 may forward the information from the error message to a network administrator.

For example, at box 460, the processing resource included in the management entity 405 may process the information included in the error message and report the error to a network administrator. In this way, the network administrator may take action to determine the root cause of the error which may prevent future errors and minimize network disruption. In some examples, it may be possible for the management entity 405 to determine which controller the second AP 400-2 is failing to connect. Based on the determination, the management entity 405 may generate a corrective update which includes a group (e.g., a new controller) to which the second AP 400-2 is to establish communication. The corrective update generated by the management entity 405 may be in the form of a command that may be transmitted to the second AP 400-2 using backchannel device communication (e.g., the backchannel device communication 107 of FIG. 1) and executed on the second AP 400-2, thereby correcting the error.

For example, at box 462, the management entity 405 may forward the corrective update to the first AP 400-1, and the first AP 400-1 may transmit the corrective update to the first backchannel device 406-1. Because the second AP 400-2 is experiencing an error, it is not able to receive or transmit using its own signaling. Thus, the first AP 400-1 and the second AP 400-2 may utilize backchannel device communications between their respective backchannel devices 406-1, and 406-2. For example, at box 464, the first AP 400-1 may transmit the corrective update to the second AP 400-2 via the connection between the first backchannel device 406-1 and the second backchannel device 406-2. In some examples, the transmission described at block 464 may be accomplished by the first AP 400-1 instructing the first backchannel device 406-1 to access a remote attestation service (e.g., BluConsole service) that may be running on the second backchannel device 406-2. For example, the remote attestation service may be a serial cable replacement for accessing the second AP 400-2. In some examples, this connection between the first backchannel device 406-1 and the remote attestation service may allow for a network administrator to connect to the second AP 400-2 via the connection to the remote attestation service on the second backchannel device 406-2; thus, execute instructions to and from the second AP 400-2.

For example, at block 466, after the first backchannel device 406-1 has established a connection to the second backchannel device 406-2 via accessing the remote attestation service, the first backchannel device 406-1 may transmit the read/write characteristics (e.g., the corrective update) to the remote attestation service. For example, at block 468, the remote attestation service on the second backchannel device 406-2 may receive the corrective update, where executing the corrective update on the remote attestation service is equivalent to executing the corrective update on the second AP 400-2. In this way, the first AP 400-1 may execute, via the connection between the first backchannel device 406-1 and the second backchannel device 406-2, the corrective update, wherein the corrective update corrects the error.

For example, at block 470, the corrective update may be executed on the second AP 400-2 which may restore the second AP 400-2 to resume communication. The corrective update may have included a new group to which the second AP 400-2 may communicate. For example, the new group may include information about a new and/or corrected controller to which the second AP 400-2 may connect. With it's communication restored, the second AP 400-2 may communicate with other network devices and controllers without the use of backchannel communications.

As described by examples in connection with FIG. 4, backchannel device communication allows for the second AP 400-2 to communicate with the first AP 400-1 to correct an error experienced by the second AP 400-2. Without backchannel device communication between the first backchannel device 406-1 and the second backchannel device 406-2, the second AP 400-2 may reside in a perpetual error state. Because the first AP 400-1 has a direct uplink to the management entity 405, the first AP 400-1 is able to provide recovery to the second AP 400-2. Further, the error message transmitted via the backchannel devices 406-1 and 406-2 to the management entity 405 and may provide information about the root cause of the failure of the second AP 400-2 to a network administrator, which may have otherwise been inaccessible.

FIG. 5 illustrates an example management entity 505 including a processing resource 502 and a non-transitory machine-readable memory resource 504 for backchannel device communications consistent with the disclosure. The management entity 505, the processing resource 502, and the non-transitory memory resource 504, illustrated in FIG. 5 may be analogous to the elements illustrated in FIGS. 1, 2, 3, and 4. A memory resource, such as the non-transitory memory resource 504, may be used to store instructions (e.g., 526, 528, 530, 532, and 534) executed by the processing resource 502 to perform the operations as described herein. The operations are not limited to a particular example described herein and may include additional operations such as those described with regard to the management entity 405 described in connection with FIG. 4.

The non-transitory memory resource 504 may store instructions 526 executable by the processing resource 502 to receive, from a first AP (e.g., the first AP 401-1 of FIG. 4), an error message related to an error experienced by a second AP (e.g., the second AP 400-2 of FIG. 4). For example, the processing resource 502 included in the management entity 505 may process the information included in the error message and report the error to a network administrator. In this way, the network administrator may take action to determine the root cause of the error which may prevent future errors and minimize network disruption. Based on the information in the error message, and processed by the management entity 505, the management entity 505 may take action to correct the error experienced by the second AP.

For example, the non-transitory memory resource 504 may store instructions 528 executable by the processing resource 502 to generate a corrective update based on the information included in the error message. The corrective update generated by the management entity 505 may include a new group designating a new controller to which the second AP may connect. The management entity 505 may take action to move the corrective update to the second AP such that the error may be corrected, and the second AP may resume communication within the network.

For example, the non-transitory memory resource 504 may store instructions 530 executable by the processing resource 502 to forward the corrective update to the first AP. However, because the second AP is experiencing an error, it may be unable to communicate directly with the first AP to receive the corrective update. For this reason, the first AP may utilize backchannel device communication (e.g., the backchannel device communication 107 of FIG. 1) to correct the error experienced by the second AP.

For example, the non-transitory memory resource 504 may store instructions 532 executable by the processing resource 502 to transmit, via the first AP, the corrective update to the second AP, via a connection between a first BLE device (e.g., the first backchannel device 406-1 of FIG. 4) and a second BLE device (e.g., the second backchannel device 406-2 of FIG. 4). Because the first and the second BLE devices receive and transmit communications differently than APs the BLE devices may communicate the corrective update while the second AP is experiencing an error and in incapable of transmitting and receiving communications. In this way, the first AP may transmit the corrective update from the management entity 505 to the second AP utilizing backchannel communications.

For example, the non-transitory memory resource 504 may store instructions 534 executable by the processing resource 502 to execute via the first AP, via the connection between the first BLE device and the second BLE device, the corrective update where the corrective update corrects the error. In some examples, the backchannel device communication between the first BLE device and the second BLE device may include a remote attestation service. For example, the connection between the first BLE device and the second BLE device may include the first BLE device transmitting the corrective update to a remote attestation service included on the second AP. In this example, the first AP may transmit the corrective update as bytes via the connection between the first BLE and the second BLE and may execute the corrective update via the remote attestation service that is included on the second AP.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a plurality of additional examples of the present disclosure. In addition, the proportion and the relative scale of the elements provided in the figures are intended to illustrate the examples of the present disclosure and should not be taken in a limiting sense.

What is claimed:

1. An access point, comprising:
a backchannel device;
a processing resource; and
a non-transitory memory resource including instructions executable by the processing resource to:
transmit an error message to the backchannel device indicating an error has occurred on the access point;
transmit, via the backchannel device, the error message to a different backchannel device included on a different access point to alert the different access point of the error;
receive, via the backchannel device, a corrective update including corrective information from the different access point; and
execute corrective information included in the corrective update received by the backchannel device, wherein executing corrective information corrects the error.

2. The access point of claim 1, wherein the error message includes a unique error code that indicates information related to a particular failure experienced by the access point.

3. The access point of claim 1, wherein the error experienced by the access point includes a failure of the access point to establish communication with a management entity.

4. The access point of claim 1, wherein the error message is a special packet that includes a unique error code, an identification of the access point, and an identification of a management device, wherein the access point has failed to establish a connection with the management device.

5. The access point of claim 1, wherein the memory resource further include instructions executable by the processing resource to:
transmit, via the backchannel device, a network packet to the different access point; and
receive, via the backchannel device, a request for information about the error from the different access point in response to the different access point having received the network packet.

6. The access point of claim 5, wherein the request includes:
a unique error code corresponding to the error;
an identification value corresponding to the access point; and
an identification of a management device, wherein the access point has failed to establish a connection with the management device.

7. The access point of claim 1, wherein the memory resource further include instructions executable by the processing resource to determine a loss of connectivity with a controller when successive connection attempts to the controller have failed.

8. The access point of claim 7, wherein the instructions to transmit the error message to the backchannel device further include instructions to transmit the error message to the different backchannel device in response to the determination that a particular number of successive connection attempts to the controller have failed.

9. An access point, comprising:
a backchannel device;
a processing resource; and
a non-transitory memory resource including instructions executable by the processing resource to:
receive an error message via the backchannel device indicating that a different access point has experienced an error;
transmit the error message to a management entity;
receive a corrective update from the management entity based on the error message; and
transmit the corrective update to the different access point via the backchannel device to correct the error.

10. The access point of claim 9, further comprising an uplink to the management entity to transmit and receive the error message, wherein the different access point is not connected to the management entity.

11. The access point of claim 9, wherein the memory resource further include instructions executable by the processing resource to determine, based on a special packet having been received from the different access point, an error code indicating the error experienced by the different access point, the identity of the different access point, and a type of failure experienced by the different access point.

12. The access point of claim 9, wherein the access point receives the error message from the backchannel device in response to executing instruction for the backchannel device to transmit a request packet to the different access point.

13. The access point of claim 9, wherein the corrective update is received by a different backchannel device that is included on the different access point.

14. The access point of claim 9, wherein the memory resource further include instructions executable by the processing resource to execute the corrective update onto the different access point using a remote attestation service included on the different access point, wherein executing the corrective update corrects the error.

15. The access point of claim 14, wherein the backchannel device connects to a different backchannel device included on the different access point and the corrective update is transmitted through byte characteristics to the remote attestation service included on the different access point.

16. The access point of claim 9, wherein the corrective update includes a group to which the different access point is to establish communication.

17. A system, comprising:
a first access point including a first Bluetooth Low Energy (BLE) device;
a second access point including a second BLE device; and
a management entity including:
an uplink to the first access point;
a processing resource; and
a non-transitory memory resource including instructions executable by the processing resource to:
receive, from the first access point, an error message related to an error experienced by the second access point, wherein the error message was transmitted from the second BLE device included on the second access point and received by the first BLE device on the first access point;
generate a corrective update based on the information included in the error message; and
forward the corrective update to the first access point, the first access point to:
transmit the corrective update to the second access point, via a connection between the first BLE device and the second BLE device; and
execute, via the connection between the first BLE device and the second BLE device, the corrective update, wherein the corrective update corrects the error.

18. The system of claim 17, wherein the error message includes:
a unique error code corresponding to the error experienced by the second access point;
an identification value corresponding to the second access point; and
a group indicating a management entity to which the second access point has failed to connect.

19. The system of claim 17, wherein the connection between the first BLE device and the second BLE device includes the first BLE device transmitting the corrective update to a remote attestation service included on the second access point.

20. The system of claim 19, wherein the first access point transmits the corrective update as bytes via the connection between the first BLE and the second BLE and executes the corrective update via the remote attestation service that is included on the second access point.
